(19) United States
(12) Patent Application Publication
(10) Pub. No.: US 2009/0164313 A1
(43) Pub. Date: Jun. 25, 2009

(54) METHOD FOR CREATING AND OPERATING A PERMISSION-BASED MOBILE MARKETING MARKETPLACE

(76) Inventors: ANDREW F. JONES, Ankeny, IA (US); TIMOTHY J. GIFFORD, West Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/962,827

(22) Filed: Dec. 21, 2007

(51) Int. Cl. G06Q 30/00

(52) U.S. Cl. 705/14

(57) ABSTRACT

A method for a consumer to receive compensation to subscribe to receiving marketing messages for certain marketers. The method allows for an interactive web site allowing a consumer to store a plurality of personal information and set the rate of compensation for each marketing message received, the marketer accessing a searchable database of consumers' personal information and identifying certain consumer criteria and a maximum price the marketer will pay to a consumer to receive the marketer's message, the consumer and marketer being able to edit information at any time, the marketer sending one or more marketing messages to a list of consumers which meet the marketer's criteria, and the consumer receiving compensation at the request rate for each marketing message received.

### FIELD OF THE INVENTION

The present invention generally relates to a method for a cell phone user to grant a marketer permission to send marketing messages to the user's cell phone in exchange for compensation.

### BACKGROUND OF THE INVENTION

Since the earliest days of advertising, companies have fought for the attention of consumers through a myriad of media to entice the purchase of goods or services. Today's consumer is bombarded with hundreds, if not thousands, of marketing messages each day; messages that the consumer did not ask for and, in most cases, do not want. The advent of direct marketing provided the opportunity for companies to advertise directly to consumers at many different locations. Catalogs, first-class mail, telemarketing, and e-mail are some examples of direct marketing techniques that are currently utilized to promote the sale of goods or services. Marketers today face challenges that are far different than those with which the industry contended during its explosive growth over the last twenty years. These challenges include a consumer base which is more diverse; increased marketing materials making their way to each consumer; increased costs of advertising; consumers who are more demanding as to expectancy of service and delivery; and a consumer base which is presented with increasingly attractive alternatives to traditional mail for the direct purchase of goods or services.

Today marketers are using mobile marketing as a way to market directly to customers and prospects. Mobile marketing is currently conducted whereby the marketer is required to build its own list for exclusive use. For example, a marketer builds its mobile marketing list by obtaining permission from the consumer audience either by direct opt-in (i.e., consumers give the marketer their cell phone number directly) or by “short-code” opt-in whereby the consumer sends a text message with one work to a specific short code (i.e., text message “pizza” to “short code” 54321). A double opt-in system requires the consumer to reply “yes” to a follow-up text message sent by the marketer before full scale marking begins. Although these current marketing models and methods may be effective once up and running, they are slow and costly to build, and offer no guarantee of delivering to a consumer information regarding a good or service for which the consumer is directly interested. Further, these opt-in methods carry no assurance that the consumers opting in, and later marketed to, are consumers that are within the marketers' profile of target consumers.

The method of the present invention addresses the gaps in the current marketing methods. A primary object or advantage of the present invention is a method which allows consumers and approved marketers to participate in a price- and permission-based relationship. In essence, the consumer is a subscriber to the price- and permission-based marketing relationship with an intermediary that aggregates permissions and makes them available to approved marketers. Another object or advantage of the present invention is that the permissions obtained from consumers are aggregated and marketers may gain access to those same consumers. The consumer may receive marketing messages from selected marketers via SMS text message, MMS text message, voicemail or other cell-phone-enabled medium. This relationship benefits subscribers by interacting on their terms and receiving rewards for their time and attention with real money, and marketers benefit by gaining increased access and attention from subscribers to their marketing messages via a mass-market permission marketing engine.

### BRIEF SUMMARY OF THE INVENTION

Therefore it is a primary object, feature, or advantage of the present invention to improve upon the state of the art.

Another object, feature, or advantage of the present invention is to provide a method for any consumer to opt-in and become a subscriber to receive marketing messages from any marketer who uses the mobile marketing marketplace.

Yet another object, feature, or advantage of the present invention is to provide a method for a subscriber to opt out of receiving further messages from a specific marketer.

A still further object, feature, or advantage of the present invention is to provide a method for a subscriber to receive compensation for receiving marketing messages via the subscriber's cell phone or other device.

Another object, feature, or advantage of the present invention is to provide a method which allows the subscriber to set the level of compensation for each marketing message received.

It is a further object, feature, or advantage of the present invention is to provide a method which allows the subscriber to adjust in real time the level of compensation received for each marketing message received.

A still further object, feature, or advantage of the present invention is to provide a method which allows any consumer to opt-in once to receive messages from multiple marketers rather than having to opt-in for each marketer individually.

Another object, feature, or advantage of the present invention is to provide a method for marketers to purchase access to a list of opted-in subscribers.

Yet another object, feature, or advantage of the present invention is to provide a method for marketers to build a segmented list of subscribers based on a variety of demographic, psychographic and price-driven criteria from a database of opted-in subscribers.

Still another object, feature, or advantage of the present invention is to provide a method for marketers to save data related to previous searches or specific lists to deliver directed campaign-oriented messaging.

It is a further object, feature, or advantage of the present invention is to provide a method for marketers to set a maximum price they are willing to pay for each message sent.

A still further object, feature, or advantage of the present invention is to provide a method to identify the market profile points, such as subscriber demographics, subscriber location, as well as others, which match a marketer's profile points, ranges and price point thresholds by which a subscriber is identified to receive marketing messages.

One or more of these and/or other objects, features, and advantages of the present invention will become apparent from the specification and claims that follow. These objects, features, or advantages of the present invention do not limit the invention, as the present invention provides other features and advantages in different embodiments and in different contexts.

### BRIEF DESCRIPTION OF THE DRAWINGS

While the specification concludes with claims that particularly point out and distinctly claim the invention, it is believed that the present invention will be better understood from the following exemplary description taken in conjunction with the accompanying drawings in which:

FIG. 1 is a diagram illustrating representative steps taken by a consumer to subscribe and grant permission to receive marketing messages from one or more marketers.

FIGS. 2A and 2B are diagrams illustrating representative steps taken by the marketer to identify the preferred consumer criteria to build its list for its marketing message.

### DETAILED DESCRIPTION OF THE PREFERRED EMBODIMENT

The present invention will be described as it applies to its preferred embodiment. It is not intended that the present invention be limited to the described embodiment. It is intended that the invention cover all modifications and alternatives which may be included within the spirit and scope of the invention.

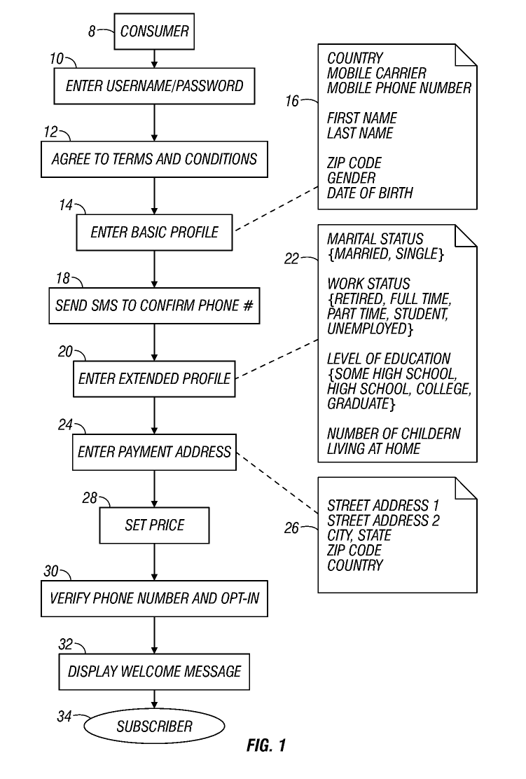

FIG. 1 is a diagram illustrating representative steps taken by a consumer to subscribe and grant permission to receive marketing messages from one or more marketers. In FIG. 1, a consumer 8 accesses an interactive web site to enter a user name and password 10. The interactive web site provides a convenient means to collect and store data related to the consumer's profile. The consumer agrees to the terms and conditions 12 of the interactive web site offering permission-based marketing messages. The consumer enters a basic profile 14 into the interactive web site. The basic profile includes information such as country of residence, information related to the mobile carrier and phone number, name, zip code, gender, and date of birth, but may include other personal information as well 16. The consumer is not necessarily limited to receiving marketing messages through a cell phone, but may also designate voicemail, text messages, emails, video, photo, bar codes, or other medium. The consumer sends a message to confirm the mode of receipt, in this example a phone number 18. In some instances, the consumer may then choose to enter additional personal information referred to as an extended profile 20. The consumer's extended profile may include, without limitation, information such as marital status, work status, level of education, number of children living at home, or other information 22. This information more narrowly profiles the consumer and makes available to the marketer more specific criteria upon which to base any targeted marketing message. The consumer then enters an address at which to receive payment for the marketing messages received 24, 26. Next, the consumer sets a price at which the consumer will be compensated for each marketing message received 28. It should be appreciated that the consumer may adjust the price the consumer will demand for each marketing message at any time and in real time. The ability to adjust the price per marketing message by the consumer is a benefit to the consumer to control the number of marketing messages received. The consumer verifies permission to receive marketing messages by entering a phone number or other means of verification 30. The consumer receives an acknowledgement that the consumer has opted in to receive marketing messages 32. In one embodiment, a double opt-in system requires the consumer to affirmatively acknowledge a subscription to the permission-based marketing marketplace. Once an acknowledgement is received by the consumer, or the consumer affirmatively acknowledges opting in to receive marketing messages, the consumer becomes a subscriber to the permission-based marketing marketplace 34. This process also allows the consumer to opt in to subscribe to multiple marketers during a single subscribing session on the interactive web site. The interactive web site aggregates the profile information from all subscribers into a searchable database. A significant feature of the present invention is that the consumer can opt out of the permission-based marketing marketplace at any time, in real time.

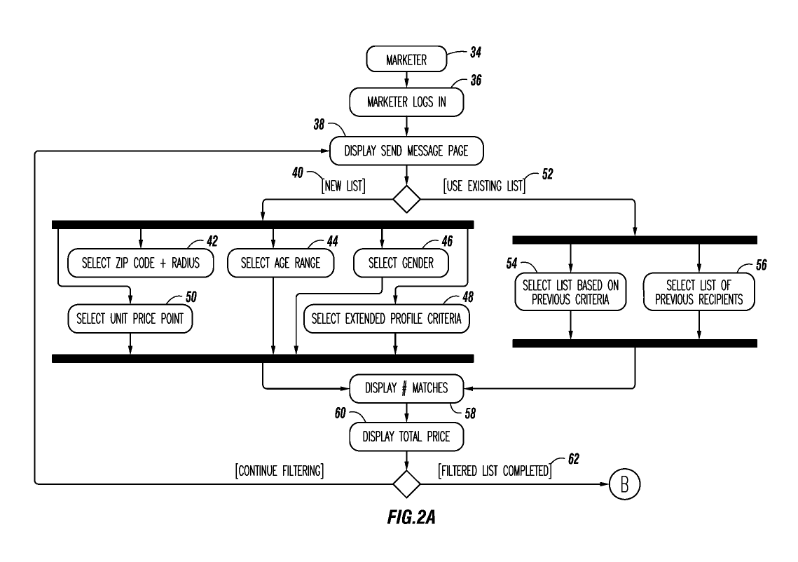

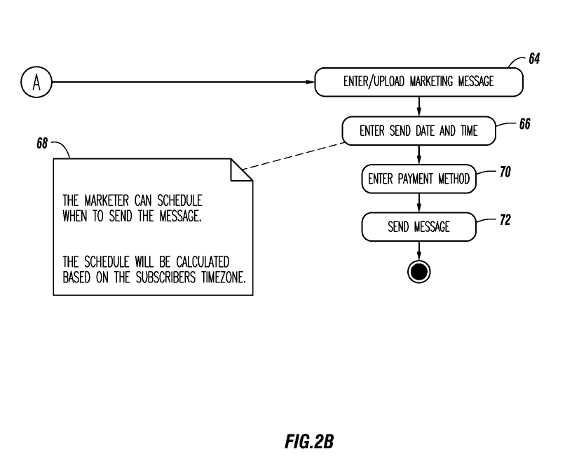

FIGS. 2A and 2B are diagrams illustrating representative steps taken by the marketer to set up an account on the interactive web site to access the searchable database to identify its preferred consumer criteria to build its list for sending marketing messages. The marketer 34 logs in to an interactive web site 36. The marketer accesses the searchable database which contains the profile information of all subscribers who have opted in to receive marketing messages. The marketer builds a subscriber list and writes its marketing message 38. The marketer has two choices at this juncture. The marketer may choose to build a new subscriber list 40 or access an existing subscriber list 52. If the marketer chooses to build a new subscriber list 40, the marketer selects its preferred subscriber criteria. These criteria may include zip code and surrounding area 42, age range of subscriber 44, gender 46, as well as other subscriber profile features from the subscriber's extended profile 48. The marketer then selects the maximum price it is willing subscribers and the selected criteria of the marketer 58. The marketer is then provided information via the web site as to the number of subscribers who meet the marketer's criteria, to include the number of subscribers who are at or below the maximum price set by the marketer, and the total price the marketer will have to pay to send a marketing message to the list of subscribers 60. The marketer may adjust its maximum price and edit or filter its subscriber list at any time, in real time. The marketer purchases a final list of subscribers which meet its criteria 62. The marketer enters and uploads its marketing message 64. The marketer then enters the date and time it would like to send its marketing message to its subscriber list 66. The marketer can schedule when to send its message based on several factors to include the time zone in which each subscriber resides 68. The marketer enters it payment method 70 and sends its marketing message 72. Compensation is paid to the subscriber upon receipt of the marketing message. If a marketer has previously identified a subscriber list, it can save and access this same subscriber list at another time 52. The marketer may select a subscriber list based on previously identified criteria 54 or select a list of previous subscribers who have received a particular marketing message 56. A history of the marketing messages and associated compensation paid for the message is saved on the web site.

The present invention contemplates that the present invention provides value in a number of ways. A consumer has the ability to opt-in and opt-out at any time, in real time, with regard to the permission-based marketing marketplace. A consumer is not locked in to a certain time period to receive marketing messages. The consumer may also adjust the level of compensation demanded for each marketing message. Adjusting the level of compensation is one way that the consumer can limit the number of marketing messages received. By providing additional personal information in the extended profile, the consumer will receive marketing messages that are even more relevant to the consumer and may be able to demand a higher level of compensation per marketing message.

The present invention as well provides value to the marketer. The marketer is able to target its marketing messenger to those consumers who meet the demographic, psychographic, price-driven, or other criteria of the marketer's product or service. It is with relative ease that the marketer builds its subscriber list through a searchable database. Further, this system provides a method for marketers to test-market new products or services to consumers who meet certain criteria and who are interested and incentivized to receive marketing messages.

It is to be understood that although cell phone and other types of mobile devices are described in the preferred embodiment, the consumer may elect from any one of a number of medium, without limitation, to receive marketing messages.

The following example is intended to illustrate, but not limit the present invention.

### EXAMPLE

Consumer A accesses an interactive web site and creates an account. Consumer A completes her profile, telling the system that she is a woman, born on Jul. 1, 1979, lives in zip code 50309, and has a mobile phone number of 555-555-1234. Consumer A also completes an extended profile telling the system that she is married, has one child, and owns her own home. Consumer A sets her price at $0.25 per marketing message. A confirmation text message is sent to her mobile phone and she replies “yes,” completing the double opt-in. At that point, Consumer A's profile is placed into a searchable database with other subscribers.

A few days later, Marketer M comes along and signs into the interactive web site. Marketer M has recently opened a new store in the Des Moines, Iowa area and would like to tell young mothers about it. Marketer M conducts a search of the subscriber database for mothers ages 22-35 that live in or within 50 miles of area code 50309 and whose price is not higher than $0.50 per marketing message. This search returns 2,239 subscribers who fit the marketer's criteria, among them is Consumer A. The marketer than enters the following marketing message: “Attention young mothers! Show this message at the Grand Opening of “OH BABY” for 20% off clothes and toys. Friday and Saturday only at Big Woods Mall.”

The message is schedule to send at 8:00 a.m. Friday and at that time, Consumer A's mobile phone buzzes, and she receives the message. Consumer A then goes to her page on the web site and sees her account has been credited for $0.25.

While the present invention has been described in conjunction with the specific embodiments outlined in the example above, it is but one embodiment of the present invention. The present invention is not to be limited to this example, as the present invention contemplates that numerous variations, options, and alternatives may fall within the broad spirit and scope of the invention a defined in the claims.

What is claimed is:

1. A method for a consumer to subscribe to receive marketing messages from a marketer, comprising:
providing an interactive web site to allow a consumer to create a first account to store a plurality of personal information associated with said consumer and accessible by said consumer using a password;
determining by said consumer the level of compensation said consumer will accept from said marketer in exchange for receiving a marketing message;
storing consumer's said level of compensation as part of said plurality of personal information;
receiving confirmation from said interactive web site that said consumer's said plurality of personal information is stored;
providing a means for said consumer on said interactive web site to subscribe to receive said marketing message from said marketer upon said confirmation; and
receiving compensation by said consumer for each marketing message received.

2. The method of claim 1 wherein said marketer accesses said plurality of personal information and selects consumers based on particular criteria to which to send said marketing message.

3. A method for a marketer to select consumers to send marketing messages, comprising:
providing an interactive website allowing said marketer to create a second account to access information related to said consumers;
identifying by said marketer on said interactive website the preferred criteria of said consumers to send said marketing message;
setting a maximum price per message said marketer will pay for each marketing message sent to said consumers;
compiling a list of consumers by said marketer which match said preferred criteria and which meet or fall below said maximum price per message set by said marketer;
purchasing by said marketer said list of consumers meeting said preferred criteria;
saving said list of consumers by marketer;
saving marketer's said preferred criteria;
writing said marketing message to send to said list of consumers;
scheduling a delivery time of said marketing message to said list of consumers relative to said consumers' time zones;
sending said marketing message to said list of consumers;
paying said consumers for each said marketing message received by said consumers; and
viewing the history of each said marketing message for said marketer and associated compensation to said consumer for said message.

4. The method of claim 3 wherein said consumers subscribe to receive said marketing messages through an interactive web site.

5. A method for a consumer to grant a marketer permission to send marketing messages to a consumer, comprising:
providing an interactive web site to allow a consumer to create a first account to store a plurality of personal information associated with said consumer and accessible by said consumer using a password;
determining by said consumer the level of compensation said consumer will accept from said marketer in exchange for receiving a marketing message;
storing consumer's said level of compensation as part of said plurality of personal information;
receiving confirmation from said interactive web site that said consumer's said plurality of personal information is stored; and
providing a means for said consumer on said interactive web site to subscribe to receive said marketing message from said marketer upon said confirmation.
identifying said consumer as a subscriber after receiving said confirmation;
identifying said consumer's plurality of personal information as a subscriber profile;
aggregating said subscriber profile into searchable database;
providing an interactive website allowing said marketer to create a second account to access said searchable database;
identifying by said marketer from said searchable database the preferred subscriber profile to send said marketing message;
setting a maximum price per message said marketer will pay for each marketing message sent to said subscriber;
compiling a list of subscribers by said marketer from said subscriber profile which match or fall below said maximum price per message set by said marketer identified as marketer's criteria;
purchasing by said marketer said list of subscribers meeting said marketer's criteria;
saving said list of subscribers by marketer;
saving said marketer's criteria;
entering a marketing message by said marketer;
scheduling a delivery time relative to said subscribers' time zones of said marketing message to said list of subscribers;
sending said marketing message to said list of subscribers;
viewing the history of each said marketing message for said marketer and associated compensation to said subscriber for said message; and
receiving compensation by said subscriber for each marketing message received.

6. The method of claim 5 wherein said plurality of information includes medium to receive said marketing message, first and last name, zip code, gender, date of birth, and home address.

7. The method of claim 5 wherein said consumer completes an extended profile to store in said first account.

8. The method of claim 7 wherein said extended profile includes marital status, work status, level of education, and family information of said consumer.

9. The method of claim 5 wherein said subscriber adjusts at any time the level of compensation said subscriber will accept from said marketer in exchange for receiving said marketing message.

10. The method of claim 5 wherein said subscriber's profile may be updated at any time.

11. The method of claim 5 wherein said subscriber may opt out from receiving said marketing messages from said marketer.

12. The method of claim 5 wherein said marketer's criteria may include said subscriber's gender, age range, zip code, resident address, geographic location, said level of compensation, level of education, or other such criteria.

13. The method of claim 5 wherein said marketer may adjust said marketer's criteria.

14. The method of claim 5 wherein said marketer may adjust said maximum price per message.

15. The method of claim 5 wherein said marketer may purchase more than one said list of subscribers.

16. The method of claim 5 wherein said marketer may send more than one marketing message to said subscriber.
